(19) United States
(12) Patent Application Publication
(10) Pub. No.: US 2012/0070365 A1
(43) Pub. Date: Mar. 22, 2012

(54) PROCESS AND APPARATUS FOR PREPARING MOLECULAR BROMINE

(76) Inventors: Mira Bergstein Freiberg, Omer (IL); Aharon Meirom, Arad (IL); Dan Kopel, Beers-sheva (IL); Shaul Shmilowitz, Meitar (IL); Naim Faza, Ranla (IL)

(21) Appl. No.: 13/148,189

(22) PCT Filed: Feb. 9, 2010
(86) PCT No.: PCT/IL10/00111

§ 371 Date: Oct. 18, 2011

Related U.S. Application Data
(60) Provisional application No. 61/150,918, filed on Feb. 9, 2009.

(51) Int. Cl. C01B 7/09; B01J 7/00

(52) U.S. Cl. 423/504; 422/107; 423/500

(57) ABSTRACT

A process for preparing gaseous elemental bromine and transferring it to a site of its intended use, comprising feeding a bromide (Br—) source, an oxidant and an acid into a reaction vessel to form an acidic aqueous reaction mixture, oxidizing the bromide at a temperature in the range between 59 C and the boiling point of said reaction mixture, thereby forming elemental bromine in a gaseous state, passing a stream of air through the reaction vessel and transferring metered amounts of the resultant mixture of air and bromine vapors to said site of use. The invention also provides an apparatus for carrying out the process.

Molecular bromine is a useful reagent in the organic synthesis of many flame retardants. Bromine is also employed for disinfection and biological control of aqueous systems. More recently, the efficacy of bromine in connection with the removal of mercury from coal-based power stations has been demonstrated.

Molecular bromine is recovered from the bromide ion (e.g., from bromide salts-containing brines) by means of chlorine oxidation. However, the transportation and storage of the liquid molecular bromine must satisfy stringent requirements. Consequently, there exists a need, in various industrial plants which utilize molecular bromine, for the in-situ generation of molecular bromine using a safe and controllable method.

U.S. Pat. No. 3,222,276 describes a process and an apparatus for producing an aqueous bromine solution, starting from a bromide-bromate solution and an acid.

U.S. Pat. No. 5,266,295 describes the oxidation of hydrogen bromide using hydrogen peroxide as an oxidizing agent in the presence of an acid.

The process according to the present invention is based on the generation of elemental bromine by means of the oxidation of bromide (Br⁻) in an aqueous solution in an acidic environment at a temperature above 59° C., preferably above 85° C. and more preferably not less than 95° C., namely, between 95° C. and the boiling point of the solution, to produce elemental bromine in a gaseous state, while passing a stream of inert gas carrier, e.g., air, through the reaction zone, thereby removing bromine vapors from the reaction zone and transferring said bromine vapors at a suitable, preset flow rate to a site (e.g., industrial plant) where the elemental bromine is intended to be used.

Thus, the invention is primarily directed to a process for preparing gaseous elemental bromine and transferring it to a site of its intended use, comprising feeding a bromide (Br⁻) source, an oxidant and an acid into a reaction vessel to form an acidic aqueous reaction mixture, oxidizing the bromide at a temperature in the range between 59° C. and the boiling point of said reaction mixture, thereby forming elemental bromine in a gaseous state, passing a stream of air through the reaction vessel and transferring metered amounts of the resultant mixture of air and bromine vapors to said site of use.

Suitable oxidizing agents for the oxidation of bromide include, for example, bromate (BrO₃⁻), hydrogen peroxide and oxygen (air) in combination with a suitable catalyst. The use of bromate as the oxidizing agent is preferred, in view of the fact that the bromate itself contributes one bromine atom to the product, and also allows the utilization of a simplified feeding method of the reactants into the reaction zone, as described in more detail below.

In its most general form, the oxidation of bromide in the presence of broamte is represented by the following chemical equation (1):

BrO₃⁻(aq)+5Br⁻(aq)+6H⁺(aq)→3Br₂(aq)+3H₂O (1)

The bromide and bromate salts are most suitably provided in the form of their alkali or alkaline earth metal salts. The acid employed in the process may be either monoprotic (for example, hydrogen chloride) or polyprotic acid (e.g., sulfuric acid). The oxidation reaction therefore involves the formation of a corresponding salt by-product.

For the more specific case where the bromide and bromate reactants are provided by their alkali salts, the general equation reduces to the following form (2):

5MBr+MBrO₃+nHₚA→3Br₂+nMₚA+3H₂O

wherein M represents a cation of an alkali metal, A is the anion of the acid, and the product of the coefficients n and p equals 6. The reaction by-product is the salt MₚA.

It is noted that when the bromide and bromate starting materials are used in the form of their alkaline earth salts (such as calcium salts), then the acid participating in the reaction is preferably a monoprotic acid, especially HCl, in order to prevent the potential precipitation of insoluble by-product calcium salts in the aqueous solution.

In practicing the continuous process provided by the invention, bromide and the oxidant, e.g., bromate, are continuously fed to a reaction zone. Preferably, aqueous solutions of bromide and bromate alkali or alkaline earth salts are used, such as sodium, potassium or calcium bromide solutions, in combination with sodium or potassium bromate solutions. The bromide and bromate salt solutions may be introduced into the reaction zone by means of two separate feed streams. However, it may be more convenient to prepare in advance a single solution combining both salts together (either by mixing the separate bromide and bromate components in water or by a suitable chemical reaction producing said components in situ). More specifically, a mixture of bromide and bromate salts may be dissolved in water to form a solution, which is held in a suitable vessel under stirring. The bromide/bromate solution is supplied to the reaction zone at a rate which varies, for example, in the range between few milliliters and few tenths or hundreds of liters per hour, according to the demand at the site of use, in which the bromine product is needed. The concentration of the solution containing the bromide and bromate salts may vary within a broad range, up to the saturation limit at the relevant temperature in which the solution is held before initiating the oxidation reaction, more specifically between 10 and 50% (w/w). The suitable concentration of the bromide/bromate starting solution is sometimes adjusted taking into account the possible precipitation of the MₚA salt by-product (sodium sulfate, sodium chloride), in case where waste treatment regulations impose such a constrain (namely, prohibit the discharge of a slurry waste). It is preferred to employ the bromide salt in a slight stoichiomteric excess relative to the bromate salt, in order to minimize, and preferably even to eliminate, the risk of obtaining bromate traces in the waste generated by the process. Thus, the amount of the bromide salt charged to the reaction vessel may be in excess of 0.01 to 10% of the stoichiometric amount.

Concurrently with the feeding of the bromide and bromate salt solutions as described above, an acid is continuously introduced to the reaction zone. An acid operable in the process is a mineral acid, such as sulfuric acid or HCl, as already mentioned above.

A key feature of the process provided by the present invention is that the rate of the generation of the bromine product by the oxidation reaction is adjusted in order to accurately satisfy the demand at the site of use, to which the continuously-produced bromine is transferred. For this purpose, one or more of the following parameters are periodically or continuously measured and, if needed, suitably adjusted, during the oxidation reaction: the pH of the reaction mixture, the temperature of the reaction mixture and the rates of feeding the reactants to the reaction zone (the bromide/bromate solution and the acid). Among the parameters noted above, it is especially useful to control the bromine generation by means of pH adjustment. It has been observed that when the pH of the reaction mixture increases to about 4.0-4.5, then the reaction becomes unacceptably slow. Accordingly, in addition to the amount of acid dictated by stoichiometry (which amount is consumed substantially instantaneously by the oxidation reaction), it is important that un-reacted acid be present in the reaction zone, in order to provide a sufficiently acidic environment for the reaction, allowing the continuous production of bromine at the required rate. More specifically, the acid is fed to the reaction zone at a rate which is adjusted in order to maintain the pH of the reaction zone within the range below 4.5, and preferably below 3.5 and even more preferably between 1 and 2.5. As indicated above, the excess of acid also serves for minimizing, and preferably eliminating, the bromate presence in the waste discharged from the reaction zone. pH value lower than 1 may also be applied in the reaction zone.

The reaction zone is maintained under heating, such that the molecular bromine is generated in a gaseous form, in order to allow the convenient removal of the bromine vapors by stripping. More specifically, the reaction is preferably carried out at a temperature above 59° C., more preferably in the range between 85° C. and the boiling point of the solution, e.g., between 95 and 120° C., and more specifically at about 101-103° C. Under these conditions, the elemental bromine produced may be conveniently separated from the reaction zone by stripping. More specifically, a stream of inert gas carrier, e.g., air, is injected into and passed through the reaction zone, whereby the bromine vapors generated are being continuously removed from the reaction zone. The throughput of the air flow is adjusted in order to remove from the reaction zone and transfer the necessary amount of molecular bromine, as required at the site of use.

Generally, there is no need to further treat (e.g., condense or purify) the gaseous bromine recovered by the stripping operation, such that the bromine vapors carried by the air stream may be directly conveyed to, and used in, the intended site of use. An advantage associated with the removal of the product by means of the stripping as described above is that the rate of injection of the carrier gas into the reaction zone, and the concentration of the bromine product in the carrier gas may be measured and adjusted in order to meet with the need at the site of use.

As indicated above, the process may run using bromide and an oxidizer such as hydrogen peroxide, in which case the reactants are fed to the reaction zone through two separate streams.

As indicated by the chemical equation (2), the invention involves the formation of the salt MₚA as a by-product (e.g., sodium sulfate). The liquid phase of the reaction zone, which consists of an aqueous solution comprising the salt MₚA and possibly a small amount of bromine is continuously discharged from the reaction zone and is subsequently treated using conventional means, including bleaching with a reducing agent such as sodium bisulfite, in order to destroy bromine traces, if needed. Various known techniques may be used for the detection or quantification of bromine present in the discharged liquid phase. For example, the Redox (reduction-oxidation) potential of the solution discharged from the reaction vessel is periodically or continuously measured. The Redox potential is indicative of the presence of bromine traces in the discharged waste solution, and is measured using a commercially available Redox electrode which is in contact with said solution. Based upon the potential measured by the Redox electrode, the amount of the reducing agent needed for treating the solution is suitably adjusted.

As noted above, the molecular bromine generated by the process may be used in various industrial plants, and may be particularly useful in sites and plants where gaseous bromine is needed in order to produce active or electronically excited bromine species, using either thermally or radiative processes. For example, the air and bromine gaseous mixture which is generated by the process may be directed to and passed through corona discharge active zone as described, for example, in U.S. Pat. No. 6,365,112, to form active bromine species, which are contacted with a stream of mercury-contaminated gas produced in a power station, whereby the mercury is treated.

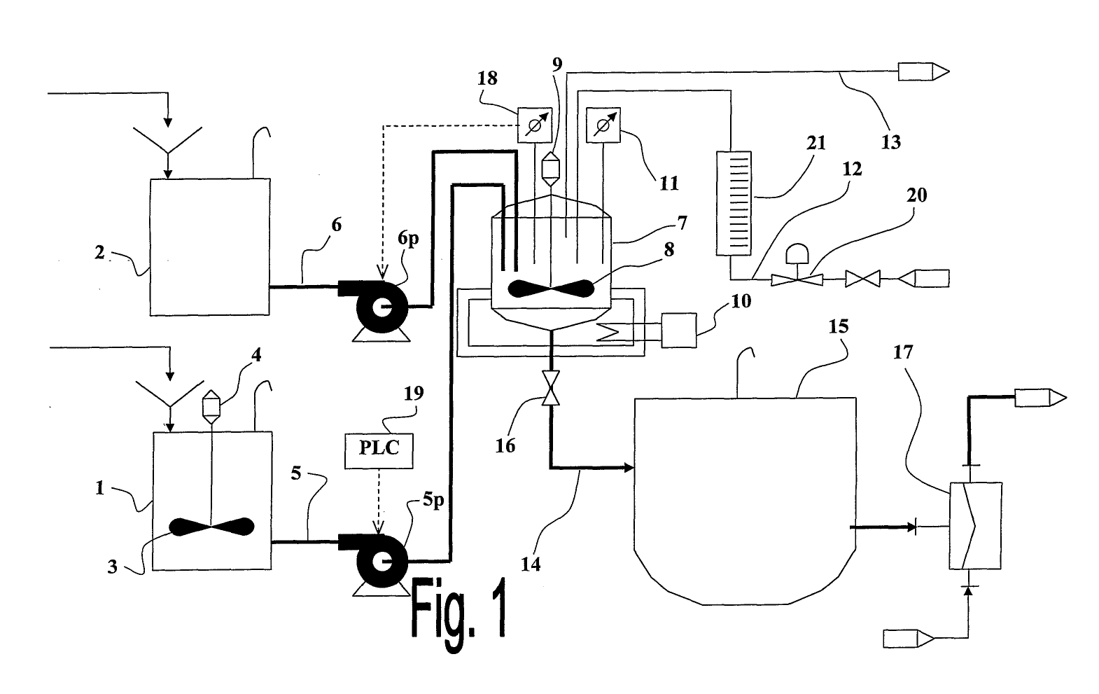

An apparatus suitable for carrying out the continuous process of the present invention is described in FIG. 1.

Vessels 1 and 2, which are made from a chemically resistant material, such as poly(tetrafluoroethylene), are used for holding the bromide/bromate solution and the acid, respectively. Vessel 1 is equipped with stirring means 3, driven by an electric motor 4. Bromide/bromate feed conduit 5 and acid feed conduit 6 enter a reaction vessel 7 suitable for the generation of bromine. The liquid streams of the bromide/bromate solution and the acid are continuously fed to the reactor 7 through said feed conduits by means of pumps 5p and 6p, respectively. Suitable pumps are capable of delivering, for example, between 40 ml and 20 liter per hour (such as Prominent Gama type 4).

The reaction vessel 7 is preferably a glass reactor provided with an agitator 8 driven by an electric motor 9, and an electrical heating element 10 connected to a temperature 11 and pH measurement devices 18. Reaction vessel 7 may be also provided by a static mixer or a suitable column.

A suitable compressor (not shown) is used for injecting air through feed conduit 12 into reactor 7, in order to strip the bromine vapors generated inside the reactor. The pressure of the air injected and its rate of flow are adjusted by pressure control valve 20 and rotameter 21, respectively. The air is fed to the reaction vessel at a rate of flow which varies, for example, in the range between few litters and several cubic meters per hour, according to the type of equipment utilized and the demand at the site of use. The stream of air is injected above the level of the liquid in the reaction vessel, and there is no need to bubble the air through the solution. The bromine vapors are removed from the reaction vessel and directed through conduit 13, which may be directly connected to the device employing the molecular bromine (not shown). On pipe 13 a bromine concentration analyzer may be provided.

The bottom of the reaction vessel 7 is connected through a conduit 14 to a waste vessel 15. The waste discharge valve and pump (air-operated pump) are indicated by numerals 16 and 17, respectively.

The apparatus may further, comprise a control unit (not shown), adapted for monitoring and managing the operation of the apparatus in order to provide a pre-set flow rate of the bromine product. The control unit may be responsive to indications received from the temperature and pH measurement devices 11, 18 and rotameter 21, and is capable, inter alia, of modifying the feeding rates supplied by pumps 5p and 6p, the heating of reactor 7 and the flow rate of the air injected into the reactor, in order to accurately satisfy the demand of molecular bromine at the application site. More specifically, as shown in the FIGURE, the operation of metering pumps 5p and 6p is modified according to a predetermined bromine flow rate indicated by numeral 19 and is further responsive to the pH measurement 18. The control unit may be implemented by a specially designed control logic circuitry, preferably by a programmable microcontroller. A bromine sensor (commercially available from Instruments Bionics, Scott or Drager) is incorporated in the apparatus such that in case of bromine leakage, an alarm signal is generated to which the control unit responds by rapidly interrupting the feeding of the reactants to the reaction vessel and stopping the heating and any other relevant operation, while discharging the content of the reactor (7) to the waste vessel and feeding the bisulfite solution into said waste vessel (15) for destroying bromine traces. The reaction vessel (7) may further include level determining means (not shown). Signals received by the control unit from the level determining means allow the opening and closure of a suitable valve at the bottom of the reaction vessel in order to maintain an essentially constant liquid volume therein.

In operation, vessels 1 and 2 are loaded with the bromide/bromate solution and the acid (98% H₂SO₄), respectively. The continuously fed streams of the bromide/broamte and the acid solutions are mixed in the reactor 7, while the instantaneously formed molecular bromine is continuously removed from the reaction mixture by means of air steam through conduit 13, which directs the bromine to the intended application site at the required, pre-determined flow rate.

During operation, the discharge valve 16 is open, and the reaction mixture consisting of an aqueous solution of the reaction by-product (e.g., sodium sulfate) and possibly bromine traces is removed from the bottom of reactor 7 and transferred to the waste vessel 15. In the event that the presence of bromine traces is detected in the waste solution (using, for example, a redox electrode (not shown) placed in container (15) and in contact with the solution, or other acceptable analytical techniques), then said solution is treated with a reducing agent (such as sodium bisulfite) for bleaching and destroying the bromine traces. A suitable set-up for measuring the Redox potential of the solution comprises a measuring electrode made of an inert metal or alloy (a platinum electrode) and a reference electrode (such as Ag/AgCl or calomel). Suitable electrodes are commercially available.

Thus, in another aspect, the invention relates to an apparatus for generating bromine, comprising: at least a first and second tanks (1, 2) for holding a solution of a bromide source, an oxidizing agent and a strong acid, respectively, which tanks are connected by means of feed conduits (5, 6) and respective metered pumps (5p, 6p) to a reaction vessel (7) equipped with an agitator (8), heating element (10), pH measurement device (18), a gas inlet opening and a gas outlet opening to which air feed and discharge lines are respectively (12, 13) connected, said air feed line (12) being optionally provided with a pressure control valve (20) and gas flow rate measurement device (21), wherein said reaction vessel (7) has an opening at its bottom to which a discharge conduit (14) is connected, said conduit (14) being also in fluid communication with a container (15), wherein said apparatus further comprises a control unit responsive to indications received from said pH measurement device (18), and said gas flow rate measurement device (21), and is adapted to modify the feed rates supplied by pumps (5p) and (6p), the heating of reactor (7) and the flow rate of the air injected into the reactor. The apparatus preferably further comprises a Redox electrode for indicating the presence of bromine traces in the waste container (15) and a container for holding a reducing agent, wherein the control unit is adapted to adjust the feed of said reducing agent into said container (15) in response to indications received from said Redox electrode.

### EXAMPLES

### Example 1

The apparatus shown in FIG. 1 was operated to carry out the oxidation reaction and to generate molecular bromine at a rate of 400 g/hour. The volumes of vessels 1, 2 and reactor 7 were 5 liters, 5 liters and 2 liters, respectively.

The following is a short procedure for preparing a suitable bromide/bromate solution which meets with the stoichiometric demands of the intended oxidation reaction.

Into a plastic container having a volume of about 25-30 liters, warm water (15 kg) is introduced. Sodium bromide (5200 g) and sodium bromate (1510 g) are then added under stirring. The salts are allowed to dissolve completely, following which additional amount of water (5 liter) is added to obtain a 20 liters solution having a bromide/bromate concentration of 25%.

Having filled each of vessels 1 and 2 with 5 liters of the bromide/bromate solution described above and the concentrated sulfuric acid, respectively, the metering pumps 5p and 6p are set to continuously feed the bromide/bromate solution and the concentrated sulfuric acid to the glass reactor 7 at rates of 2684 g/hour and 300 g/hour, respectively, by appropriately setting the operation parameters of the pumps 5p and 6p (namely, the frequency and dosing). The pH at the reactor 7 is maintained at about 1.5-2.0. The reactor 7 is heated to about 90° C. and the rate of agitation within the reactor is set to 400 rpm. Air is allowed to flow into the reactor through air pipe 12 at a flow rate of about 24 liter/min. Under these conditions, the apparatus generated the bromine at the requested flow rate of 400 g/hour.

1. A process for preparing gaseous elemental bromine and transferring it to a site of its intended use, comprising feeding a bromide (Br⁻) source, an oxidant and an acid into a reaction vessel to form an acidic aqueous reaction mixture, oxidizing the bromide at a temperature between 59° C. and the boiling point of said reaction mixture, thereby forming elemental bromine in a gaseous state, passing a stream of air through the reaction vessel and transferring metered amounts of the resultant mixture of air and bromine vapors to said site of use.

2. A method according to claim 1, wherein the bromide source is an alkali or alkaline earth metal bromide salt and the oxidant is bromate (BrO₃⁻).

3. A method according to claim 2, comprising concurrently and continuously feeding to the reaction vessel two separate feed streams, wherein the first stream comprises an aqueous solution of bromide and bromate salts and the second stream comprises an aqueous solution of a mineral acid, continuously removing the air/bromine gaseous mixture from the reaction vessel and discharging the liquid phase of the reaction mixture containing an aqueous solution of a salt by-product produced by the oxidation reaction.

4. A method according to claim 3, which further comprises treating the liquid phase withdrawn from the reaction vessel with a reducing agent for bleaching and destroying bromine traces present in said liquid phase.

5. A method according to claim 1, wherein the bromine gas produced is transferred from the reaction vessel to the site of its intended use at a flow rate which may be adjusted by modifying one or more of the following: the feeding rate of the bromide source, the oxidant and the acid to the reaction zone; the temperature of the reaction mixture; the pH of the reaction mixture; and the flow rate of the air injected to the reaction vessel.

6. A method according to claim 5, wherein the temperature of the reaction mixture is not less than 95° C.

7. A method according to claim 5, wherein the pH of the reaction mixture is less than 2.5.

8. A method according to claim 7, wherein the bromide salt in fed into the reaction vessel in a stoichiometric excess relative to the bromate salt.

9. An apparatus for generating bromine, comprising:
at least a first and second tanks (1, 2) for holding a solution of a bromide source, an oxidizing agent and an acid, which tanks are connected by feed conduits (5, 6) and respective metered pumps (5p, 6p) to a reaction vessel (7) equipped with an agitator (8), heating element (10), pH measurement device (18), a gas inlet opening and a gas outlet opening to which air feed and discharge lines are respectively (12, 13) connected, said air feed line (12) being provided with a gas flow rate measurement device (21), wherein
said reaction vessel (7) has an opening located at its bottom to which a discharge conduit (14) is connected, said conduit (14) being in fluid communication with a waste container (15), and
said apparatus further comprises a control unit responsive to indications received from said pH measurement device (18) and said gas flow rate measurement device (21), said control unit being adapted to modify the feed rates supplied by pumps (5p) and (6p), the heating of reactor (7) and the flow rate of the air injected into the reaction vessel through the feed line (12).

10. An apparatus according to claim 9, which further comprises a Redox electrode for indicating the presence of bromine traces in the waste container (15) and a container for holding a reducing agent, wherein the control unit is adapted to adjust the feed of said reducing agent into said container (15) in response to indications received from said Redox electrode.

11. A method according to claim 2, wherein the bromine gas produced is transferred from the reaction vessel to the site of its intended use at a flow rate which may be adjusted by modifying one or more of the following: the feeding rate of the bromide source, the oxidant and the acid to the reaction zone; the temperature of the reaction mixture; the pH of the reaction mixture; and the flow rate of the air injected to the reaction vessel.

12. A method according to claim 3, wherein the bromine gas produced is transferred from the reaction vessel to the site of its intended use at a flow rate which may be adjusted by modifying one or more of the following: the feeding rate of the bromide source, the oxidant and the acid to the reaction zone; the temperature of the reaction mixture; the pH of the reaction mixture; and the flow rate of the air injected to the reaction vessel.

13. A method according to claim 4, wherein the bromine gas produced is transferred from the reaction vessel to the site of its intended use at a flow rate which may be adjusted by modifying one or more of the following: the feeding rate of the bromide source, the oxidant and the acid to the reaction zone; the temperature of the reaction mixture; the pH of the reaction mixture; and the flow rate of the air injected to the reaction vessel.

14. A method according to claim 13, wherein the temperature of the reaction mixture is not less than 95° C.

15. A method according to claim 12, wherein the temperature of the reaction mixture is not less than 95° C.

16. A method according to claim 11, wherein the temperature of the reaction mixture is not less than 95° C.

17. A method according to claim 13, wherein the pH of the reaction mixture is less than 2.5.

18. A method according to claim 12, wherein the pH of the reaction mixture is less than 2.5.

19. A method according to claim 11, wherein the pH of the reaction mixture is less than 2.5.

20. A method according to claim 17, wherein the bromide salt in fed into the reaction vessel in a stoichiometric excess relative to the bromate salt.
